(19) United States
(12) Patent Application Publication
(10) Pub. No.: US 2004/0248736 A1
(43) Pub. Date: Dec. 9, 2004

(54) Herbicidal compositions comprising 3-aminobenzoylpyrazoles and safener

(75) Inventors: Monika Schmitt, Frankfurt (DE); Lothar Willms, Hofheim (DE); Frank Ziemer, Kriftel (DE); Christopher Rosinger, Hofheim (DE); Erwin Hacker, Hochheim (DE); Hermann Bieringer, Eppstein (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 10/861,859

(22) Filed: Jun. 4, 2004

(30) Foreign Application Priority Data
Jun. 6, 2003 (DE) DE 103 25 659.8

(51) Int. Cl. A01N 25/32; A01N 63/00

(52) U.S. Cl. 504/105; 504/106; 504/112

(57) ABSTRACT

There are described herbicidal compositions which comprise herbicidal compounds of formula (I) and one or more compounds of the formulae (II) to (V) which act as safener.

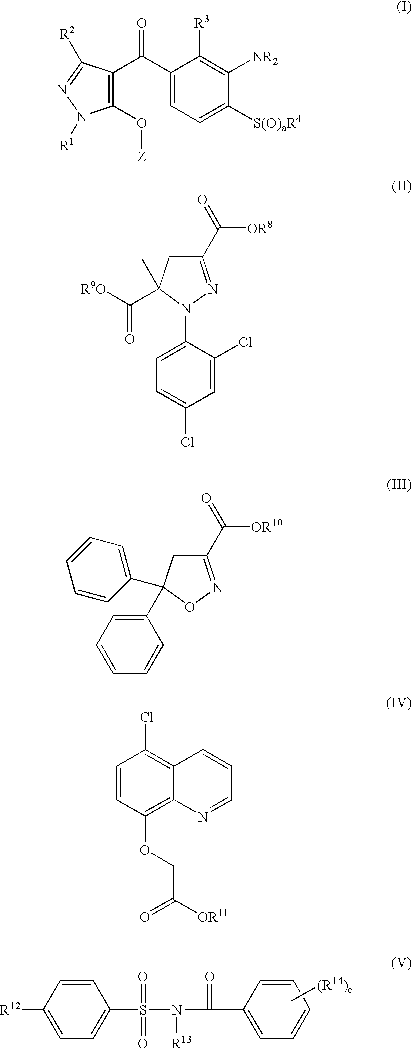

In the formulae (I) to (V), the symbols Z and R¹ to R¹⁴ are hydrogen, halogen, nitro and various organic radicals.

These herbicidal compositions are particularly well tolerated by useful plants.

The invention relates to the technical field of the crop protection products, in particular herbicide-antidote combinations (active substance/safener combinations), which are suitable for use against competing harmful plants in crops of useful plants.

A large number of herbicidal active substances are known as inhibitors of the enzyme p-hydroxyphenylpyruvate dioxygenase (HPPD). Recently, further active substances of this type have been disclosed in, for example, U.S. Pat. No. 5,824,802 and WO 96/26206.

As is the case in many other herbicidal active substances, these HPPD inhibitors, too, are not always sufficiently compatible with (i.e. not selective enough in) some important crop plants such as maize, rice or cereals, so that their use is limited substantially. In some crops, they can therefore not be used at all, or only at such low application rates that the desired broad herbicidal activity against harmful plants is not safeguarded. Specifically, many of the abovementioned herbicides cannot be employed fully selectively against harmful plants in maize, rice, cereals, sugar cane and some other crops.

To overcome these disadvantages, it is known to employ herbicidal active substances in combination with what is known as a safener or antidote. Thus, various combinations of certain HPPD inhibitors and safeners are described, for example in WO 99/66795.

A safener is understood as meaning a compound which nullifies or reduces the phytotoxic properties of a herbicide with regard to useful plants, without substantially reducing the herbicidal activity against harmful plants.

Finding a safener for a specific group of herbicides remains a difficult task since the detailed mechanisms, by which a safener reduces the harmful effect of herbicides, are not known. The fact that a compound in combination with a particular herbicide acts as a safener does not allow any conclusions to be made as to whether such a compound would also act as a safener when combined with other groups of herbicide. Thus, when using safeners for protecting the useful plants from herbicide damage, it has emerged that the safeners can still have certain disadvantages in some cases. These disadvantages include:

the safener reduces the activity of the herbicides against the harmful plants,

the properties regarding the protection of the useful plants are insufficient,

when combined with a given herbicide, the spectrum of the useful plants in which the safener/herbicide is to be employed is insufficiently wide,

a given safener cannot be combined with a sufficiently large number of herbicides.

The present invention aimed at providing novel combinations of herbicides from the group of the HPPD inhibitors and safeners which are suitable for increasing the selectivity of these herbicides with regard to important crop plants.

There have now been found novel combinations of certain herbicides from the group of the HPPD inhibitors, specifically from the group of the benzoylpyrazoles which have attached to them selected amino substituents in the 3-position of the benzoyl moiety and some safeners which increase the selectivity of these herbicides with regard to important crop plants.

The invention therefore relates to a herbicidally active composition comprising a herbicidally active amount of a component A and an antidote-effective component B, where component A is a compound of the formula (I) or its salts,

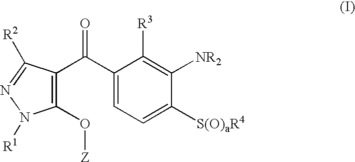

where the symbols and indices have the following meanings:

R¹ is (C₁-C₄)-alkyl, (C₃-C₄)-cycloalkyl, (C₂-C₄)-alkenyl or (C₂-C₄)-alkynyl;

R² is hydrogen, CH₂OCH₃, (C₁-C₃)-alkyl or cyclopropyl;

R³ is halogen, (C₁-C₄)-alkyl, (C₃-C₄)-cycloalkyl, (C₁-C₂)-alkoxy, CH₂OCH₃ or CH(CH₃)OCH₃;

R⁴ is (C₁-C₄)-alkyl;

Z is hydrogen, or benzyl which is substituted by a radicals selected from the group consisting of halogen, cyano, CF₃, nitro, (C₁-C₂)-alkyl and (C₁-C₂)-alkoxy;

R is hydrogen, (C₁-C₄)-alkyl, (C₃-C₄)-cycloalkyl, (C₃-C₄)-alkenyl, (C₃-C₄-alkynyl), the 4 last-mentioned substituents being substituted by v radicals selected from the group consisting of halogen, cyano, (C₁-C₄)-alkoxy, (C₃-C₄)-cycloalkoxy and (C₁-C₃)-fluoroalkoxy, or benzyl which is substituted by v radicals selected from the group consisting of halogen, cyano, nitro, CF₃, (C₁-C₂)-alkoxy and (C₁-C₂)-alkyl; or

NR₂ is a 5-, 6- or 7-membered saturated, partially saturated, unsaturated or aromatic radical comprising c nitrogen atoms and t oxygen atoms, which radical is substituted by v radicals selected from the group consisting of halogen, cyano, (C₁-C₄)-alkyl, (C₃-C₄)-cycloalkyl, (C₁-C₃)-fluoroalkyl, (C₁-C₄)-alkoxy, (C₃-C₄)-cycloalkoxy, (C₁-C₃)-fluoroalkoxy, (C₁-C₃)-alkoxymethyl and by v radicals selected from the group consisting of halogen-, cyano-, nitro-, CF₃—, (C₁-C₂)-alkoxy- and (C₁-C₂)-alkyl-substituted phenyl;

and component B is one or more compounds of the formulae (II), (III), (IV) and (V), if appropriate also in salt form,

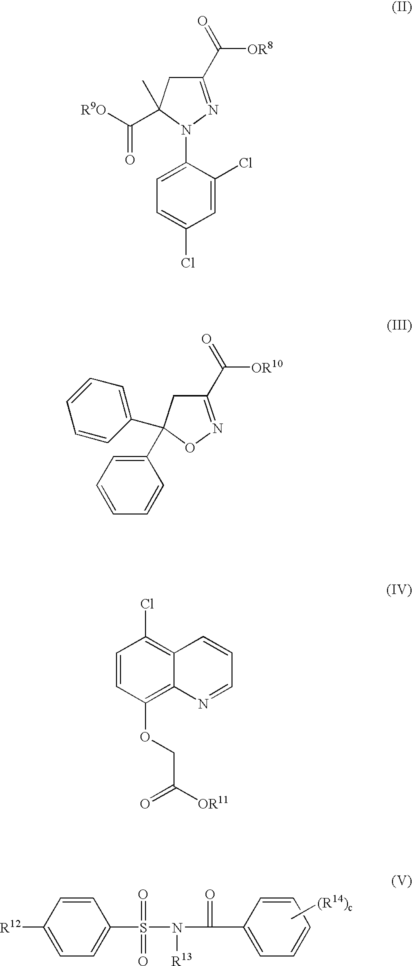

where the symbols have the following meanings:

R⁸, R⁹, R¹⁰ are in each case independently of one another hydrogen, (C₁-C₄)-alkyl;

R¹¹ is hydrogen or (C₁-C₈)-alkyl;

R¹² is CO—NR¹⁵R¹⁶ or NH—CO—R¹⁷;

R¹³ is hydrogen, (C₁-C₄)-alkyl, (C₂-C₄)-alkenyl or (C₂-C₄)-alkynyl;

R¹⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkyl-sulfinyl, (C₁-C₄)-alkylsulfonyl, (C₁-C₄)-alkoxycarbonyl or (C₁-C₄)-alkylcarbonyl;

R¹⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl comprising n hetero atoms selected from the group consisting of nitrogen, oxygen and sulfur, the seven last-mentioned radicals being substituted by v substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also by (C₁-C₄)-alkyl and (C₁-C₄)-haloalkyl;

R¹⁶ is hydrogen, (C₁-C₆)-alkyl, (C₂-C₆)-alkenyl or (C₂-C₆)-alkynyl, the three last-mentioned radicals being substituted by v radicals selected from the group consisting of halogen, hydroxyl, (C₁-C₄)-alkyl, (C₁-C₄)-alkoxy and (C₁-C₄)-alkylthio;

R¹⁷ is hydrogen, (C₁-C₄)-alkylamino, di(C₁-C₄)-alkylamino, or is (C₁-C₆)-alkyl or (C₃-C₆)-cycloalkyl, each of which is substituted by v radicals selected from the group consisting of halogen, (C₁-C₄)-alkoxy, halo(C₁-C₄)-alkoxy and (C₁-C₄)-alkylthio, or is (C₃-C₆)-cycloalkyl which is substituted by v radicals selected from the group consisting of (C₁-C₄)-alkyl and (C₁-C₄)-haloalkyl;

a is 0, 1 or 2;

c is 1 or 2;

n is 1, 2 or 3;

t is 0 or 1;

v is 0, 1, 2 or 3

including the stereoisomers.

For the purposes of the invention, herbicidally active amount means an amount of one or more herbicides which is suitable for adversely affecting plant growth.

For the purposes of the invention, antidote-effective amount means an amount of one or more safeners which is suitable for counteracting, at least partially, the phytotoxic effect of a herbicide or herbicide mixture on a useful plant.

Unless otherwise defined specifically, the following definitions apply to the radicals in the formulae (I) to (V).

The radicals alkyl, alkoxy, haloalkyl, haloalkoxy and alkylthio, and the corresponding unsaturated and/or substituted radicals can be in each case straight-chain or branched in the carbon skeleton. Alkyl radicals, also in the composite meanings such as alkoxy, haloalkyl and the like, preferably have 1 to 4 carbon atoms and are, for example, methyl, ethyl, n- or i-propyl, n-, i-, t- or 2-butyl. “(C₁-C₄)-alkyl” is the abbreviation for alkyl having 1 to 4 carbon atoms; this also applies analogously to other general definitions of radicals, with the ranges for the possible number of carbon atoms shown in brackets.

Halogen is fluorine, chlorine, bromine or iodine. Haloalkyl is alkyl which is partially or fully substituted by halogen, preferably by fluorine, chlorine and/or bromine, in particular by fluorine or chlorine, for example CF₃, CHF₂, CH₂F, CF₂CF₃, CH₂FCClFH, CCl₃, CHCl₂, CH₂CH₂Cl. Haloalkoxy is, for example, OCF₃, OCHF₂, OCH₂F, OCF₂CF₃, OCH₂CF₃ and OCH₂CH₂Cl. This also applies analogously to other halogen-substituted radicals.

Examples of 5-, 6- or 7-membered saturated, partially saturated, unsaturated or aromatic radicals which are formed by NR₂ are 1-pyrrolidinyl, 2-pyrrolidinyl, 3-pyrrolidinyl, 3-isoxazoldinyl, 4-isoxazolidinyl, 5-isoxoazolidinyl, 1-pyrazolidinyl, 3-pyrazolidinyl, 4-pyrazolidinyl, 5-pyrazolidinyl, 2-oxazolidinyl, 4-oxazolidinyl, 5-oxazolidinyl, 2-imidazolidinyl, 4-imidazolidinyl, 1,2,4-oxadiazolidin-3-yl, 1,2,4-oxadiazolidin-5-yl, 1,3,4-oxadiazolidin-2-yl, 2,3-dihydropyrrol-2-yl, 2,3-dihydropyrrol-3-yl, 2,3-dihydropyrrol-4-yl, 2,3-dihydropyrrol-5-yl, 2,5-dihydropyrrol-2-yl, 2,5-dihydropyrrol-3-yl, 2,3-dihydroisoxazol-3-yl, 2,3-dihydroisoxazol-4-yl, 2,3-dihydroisoxazol-5-yl, 4,5-dihydroisoxazol-3-yl, 4,5-dihydroisoxazol-4-yl, 4,5-dihydroisoxazol-5-yl, 2,3-dihydroisothiazol-3-yl, 2,3-dihydroisothiazol-4-yl, 2,3-dihydroisothiazol-5-yl, 4,5-dihydroisothiazol-3-yl, 4,5-dihydroisothiazol-4-yl, 4,5-dihydroisothiazol-5-yl, 2,5-dihydroisothiazol-3-yl, 2,5-dihydroisothiazol-4-yl, 2,5-dihydroisothiazol-5-yl, 2,3-dihydrooxazol-3-yl, 2,3-dihydrooxazol-4-yl, 2,3-dihydrooxazol-5-yl, 4,5-dihydrooxazol-3-yl, 4,5-dihydrooxazol-4-yl, 4,5-dihydrooxazol-5-yl, 2,5-dihydrooxazol-3-yl, 2,5-dihydrooxazol-4-yl, 2,5-dihydrooxazol-5-yl, 2,3-dihydroimidazol-2-yl, 2,3-dihydroimidazol-4-yl, 2,3-dihydroimidazol-5-yl, 4,5-dihydroimidazol-2-yl, 4,5-dihydroimidazol-4-yl, 4,5-dihydroimidazol-5-yl, 2,5-dihydroimidazol-2-yl, 2,5-dihydroimidazol-4-yl, 2,5-dihydroimidazol-5-yl, 1-morpholinyl, 2-morpholinyl, 3-morpholinyl, 1-piperidinyl, 2-piperidinyl, 3-piperidinyl, 4-piperidinyl, 3-tetrahydropyridazinyl, 4-tetrahydro-pyridazinyl, 2-tetrahydropyrimidinyl, 4-tetrahydropyrimidinyl, 5-tetrahydropyrimidinyl, 2-tetrahydropyrazinyl, 1,3-dihydrooxazin-2-yl, 3,4,5,6-tetrahydropyridin-2-yl, 1,3-dihydrooxazin-2-yl, 2-pyrrolyl, 3-pyrrolyl, 1-pyrazolyl, 3-pyrazolyl, 4-pyrazolyl, 5-pyrazolyl, 2-imidazolyl, 4-imidazolyl, 1-pyrrolyl, 2-pyrrolyl, 3-pyrrolyl, 3-isoxazolyl, 4-isoxazolyl, 5-isoxazolyl, 3-pyrazolyl, 4-pyrazolyl, 5-pyrazolyl, 2-oxazolyl, 4-oxazolyl, 5-oxazolyl, 2-imidazolyl, 1,2,4-oxadiazol-3-yl, 1,2,4-oxadiazol-5-yl, 1,3,4-oxadiazol-2-yl, 2-pyridinyl, 3-pyridinyl, 4-pyridinyl, 3-pyridazinyl, 4-pyridazinyl, 2-pyrimidinyl, 4-pyrimidinyl, 5-pyrimidinyl and 2-pyrazinyl.

Depending on the nature of their substituents, the compounds of the formulae (I) to (V) can exist in the form of their salts. Examples of such salts are hydrochlorides, ammonium salts, sodium salts and potassium salts.

The formulae (I) to (V) also comprise all stereoisomers with the same topological linkage of their atoms, and their mixtures. Such compounds comprise one or more asymmetric carbon atoms or else double bonds, which are not specifically indicated in the formulae. The stereoisomers which are possible and which are defined by their specific spatial shape, such as enantiomers, diastereomers and Z and E isomers, can be obtained by known methods from mixtures of the stereoisomers or else be prepared by stereoselective reactions in combination with the use of stereochemically pure starting materials.

Herbicidal active substances which are suitable in accordance with the invention are those compounds of the formula (I) which cannot, or not optimally, be employed on their own in crops of useful plants such as cereal crops, rice or maize since they inflict too severe a damage on the crop plants.

Herbicides of the formula (I) are known for example from U.S. Pat. No. 5,824,802 and WO-A 96/26206.

The publications cited comprise detailed information on preparation methods and starting materials. These publications are expressly referred to: they are incorporated into the present description by reference.

The compounds of the formula (II) are known for example from WO 91/07874 and the literature cited therein, or they can be prepared by, or analogously to, the processes described therein. The compounds of the formula (III) are known from WO 95/07897 and the literature cited therein, or they can be prepared by, or analogously to, the processes described therein. The compounds of the formula (IV) are known from EP-A-94349 as cloquintocet derivatives. The compounds of the formula (V) are known for example from EP-A 0 365 484, WO 97/45016 and WO 99/16744, or they can be prepared by, or analogously to, the processes described therein.

The publications cited comprise detailed information on preparation methods and starting materials. These publications are expressly referred to: they are incorporated into the present description by reference.

For the purposes of the present application, the terms “herbicidal compositions” and “herbicide/safener combinations” are understood as being exchangeable.

Of greater interest are herbicidal compositions comprising, as component B, one or more compounds of the formulae (II), (III) and (V).

Of particular interest are herbicidal compositions comprising, as component A, compounds of the formula (I) in which the symbols and indices have the following meanings:

R¹ is (C₁-C₄)-alkyl;

R² is hydrogen or (C₁-C₃)-alkyl;

R³ is halogen, (C₁-C₃)-alkyl; preferably chlorine or methyl;

R⁴ is (C₁-C₄)-alkyl;

Z is hydrogen or benzyl;

R is hydrogen or (C₁-C₄)-alkyl which is substituted by v (C₁-C₄)-alkoxy radicals, or

NR₂ is a 5-, 6- or 7-membered saturated, partially saturated, unsaturated or aromatic radical comprising c nitrogen atoms and t oxygen atoms, which radical is substituted by v radicals selected from the group consisting of halogen, cyano, (C₁-C₄)-alkyl, (C₃-C₄)-cycloalkyl, (C₁-C₃)-fluoroalkyl, (C₁-C₄)-alkoxy, (C₃-C₄)-cycloalkoxy, (C₁-C₃)-fluoroalkoxy and (C₁-C₃)-alkoxymethyl,

and the other substituents and indices have the meanings mentioned in each case further above.

Preferred herbicidal compositions are those which comprise, as component B, one or more compounds of the formulae (II) or (III) where R⁸, R⁹ and R¹⁰ independently of one another are hydrogen or (C₁-C₂)-alkyl, and the other substituents and indices have in each case the meanings mentioned further above.

Likewise preferred are herbicidal compositions which comprise, as component B, one or more compounds of the formula (V) where the symbols have the following meanings:

R¹² is CONR¹⁵R¹⁶;

R¹³ is hydrogen;

R¹⁴ is halogen, (C₁-C₄)-alkyl or (C₁-C₄)-alkoxy;

R¹⁵ is (C₁-C₆)-alkyl or (C₃-C₆)-cycloalkyl;

R¹⁶ is hydrogen or (C₁-C₆)-alkyl,

and the other substituents and indices have in each case the meanings mentioned further above.

Likewise preferred herbicidal compositions are those which comprise, as component B, one or more compounds of the formula (V) where the symbols have the following meanings:

R¹² is NH—COR¹⁷;

R¹³ is hydrogen;

R¹⁴ is halogen, (C₁-C₄)-alkyl or (C₁-C₄)-alkoxy;

v is 1,

and the other substituents and indices have in each case the meanings mentioned further above.

Especially preferred herbicidal compositions are those which comprise, as component A, one or more compounds (I-1) to (I-13) as shown in Table 1.

TABLE 1
(I)

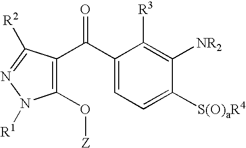

| No. | R¹ | R² | R³ | R⁴ | NR₂ | Z | a |
|---|---|---|---|---|---|---|---|
| I-1 | Et | Me | Me | Me | NHCH₂CH₂OMe | H | 2 |
| I-2 | Me | Me | Me | Me | NHCH₂CH₂OMe | H | 2 |
| I-3 | Me | c-Pr | Me | Me | NHCH₂CH₂OMe | H | 2 |
| I-4 | Et | H | Me | Me | NHCH₂CH₂OMe | H | 2 |
| I-5 | Et | H | Me | Me | NMe₂ | H | 2 |
| I-6 | Me | H | Cl | Me | NMe₂ | H | 2 |
| I-7 | Et | H | Cl | Me | NHCH₂CH═CH₂ | H | 2 |
| I-8 | Et | H | Me | Me | 1-morpholino | H | 2 |
| I-9 | i-Pr | H | Cl | Me | 1-morpholino | H | 2 |
| I-10 | Me | c-Pr | Cl | Me | 1-morpholino | H | 2 |
| I-11 | Et | Me | Cl | Me | 1-pyrazolyl | H | 2 |
| I-12 | Me | Me | Cl | Me | 1-pyrazolyl | H | 2 |
| I-13 | Me | Me | Me | Me | NHCH₂CH₂OMe | Bn | 2 |
| I-14 | Et | H | Cl | Me | 1-pyrazolyl | H | 2 |

Other especially preferred herbicidal compositions are those which comprise, as component B, one or more compounds (II-1) to (II-3) as shown in Table 2.

TABLE 2
(II)

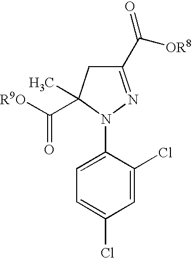

| No. | R⁸ | R⁹ |
|---|---|---|
| II-1 | H | H |
| II-2 | Me | Me |
| II-3 | Et | Et |

Likewise especially preferred herbicidal compositions are those which comprise, as component B, one or more compounds (III-1) or (III-2) as shown in Table 3.

TABLE 3
(III)

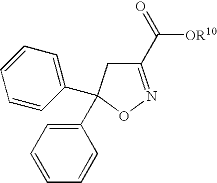

| No. | R¹⁰ |
|---|---|
| III-1 | H |
| III-2 | Et |

Likewise especially preferred herbicidal compositions are those which comprise, as component B, the compound (IV-1) as shown in Table 4.

TABLE 4
(IV)

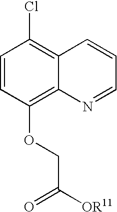

| No. | R¹¹ |
|---|---|
| IV-1 | 1-methylhexyl |

Likewise especially preferred herbicidal compositions are those which comprise, as component B, the compounds (V-1) to (V-11) as shown in Table 5.

TABLE 5
(V)

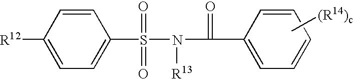

| No. | R¹² | R¹³ | (R¹⁴)_{c} |
|---|---|---|---|
| V-1 | NH—CO—NHMe | H | 2-OMe |
| V-2 | NH—CO—NMe₂ | H | 2-OMe |
| V-3 | NH—CO—CH₂OMe | H | 2-OMe-5-Me |
| V-4 | NH—CO—CH₂OMe | H | 2-OMe |
| V-5 | NH—CO-c-Pr | H | 2-OMe-5-Me |
| V-6 | NH—CO-c-Pr | H | 2-OMe |
| V-7 | CO—NH-i-Pr | H | 2-OMe-5-Me |
| V-8 | CO—NH-i-Pr | H | 2-OMe |
| V-9 | CO—NH-c-Pr | H | 2-OMe-5-Me |
| V-10 | CO—NH-c-Pr | H | 2-OMe |
| V-11 | CO—NH-c-Pr | H | 2-OMe-5-Cl |

In Tables 1 to 3, the abbreviations used therein have the following meanings:

Bn=benzyl Et=ethyl Me=methyl c-Pr=cyclopropyl i-Pr=isopropyl

Very especially preferred herbicidal compositions are those which comprise components A and B in the following combinations:

| | | | | |
|---|---|---|---|---|
| (I-1) + (II-1), | (I-2) + (II-1), | (I-3) + (II-1), | (I-4) + (II-1), | (I-5) + (II-1), |
| (I-16) + (II-1), | (I-7) + (II-1), | (I-8) + (II-1), | (I-9) + (II-1), | (I-10) + (II-1), |
| (I-10) + (II-1), | (I-12) + (II-1), | (I-13) + (II-1), | (I-14) + (II-1); | |
| (I-1) + (II-2), | (I-2) + (II-2), | (I-3) + (II-2), | (I-4) + (II-2), | (I-5) + (II-2), |
| (I-16) + (II-2), | (I-7) + (II-2), | (I-8) + (II-2), | (I-9) + (II-2), | (I-10) + (II-2), |
| (I-10) + (II-2), | (I-12) + (II-2), | (I-13) + (II-2), | (I-14) + (II-2); | |
| (I-1) + (II-3), | (I-2) + (II-3), | (I-3) + (II-3), | (I-4) + (II-3), | (I-5) + (II-3), |
| (I-16) + (II-3), | (I-7) + (II-3), | (I-8) + (II-3), | (I-9) + (II-3), | (I-10) + (II-3), |
| (I-10) + (II-3), | (I-12) + (II-3), | (I-13) + (II-3), | (I-14) + (II-3); | |
| (I-1) + (III-1), | (I-2) + (III-1), | (I-3) + (III-1), | (I-4) + (III-1), | (I-5) + (III-1), |
| (I-16) + (III-1), | (I-7) + (III-1), | (I-8) + (III-1), | (I-9) + (III-1), | (I-10) + (III-1), |
| (I-10) + (III-1), | (I-12) + (III-1), | (I-13) + (III-1), | (I-14) + (III-1); | |
| (I-1) + (III-2), | (I-2) + (III-2), | (I-3) + (III-2), | (I-4) + (III-2), | (I-5) + (III-2), |
| (I-16) + (III-2), | (I-7) + (III-2), | (I-8) + (III-2), | (I-9) + (III-2), | (I-10) + (III-2), |
| (I-10) + (III-2), | (I-12) + (III-2), | (I-13) + (III-2), | (I-14) + (III-2); | |
| (I-1) + (IV-1), | (I-2) + (IV-1), | (I-3) + (IV-1), | (I-4) + (IV-1), | (I-5) + (IV-1), |
| (I-16) + (IV-1), | (I-7) + (IV-1), | (I-8) + (IV-1), | (I-9) + (IV-1), | (I-10) + (IV-1), |
| (I-10) + (IV-1), | (I-12) + (IV-1), | (I-13) + (IV-1), | (I-14) + (IV-1); | |
| (I-1) + (V-1), | (I-2) + (V-1), | (I-3) + (V-1), | (I-4) + (V-1), | (I-5) + (V-1), |
| (I-16) + (V-1), | (I-7) + (V-1), | (I-8) + (V-1), | (I-9) + (V-1), | (I-10) + (V-1), |
| (I-10) + (V-1), | (I-12) + (V-1), | (I-13) + (V-1), | (I-14) + (V-1); | |
| (I-1) + (V-2), | (I-2) + (V-2), | (I-3) + (V-2), | (I-4) + (V-2), | (I-5) + (V-2), |
| (I-16) + (V-2), | (I-7) + (V-2), | (I-8) + (V-2), | (I-9) + (V-2), | (I-10) + (V-2), |
| (I-10) + (V-2), | (I-12) + (V-2), | (I-13) + (V-2), | (I-14) + (V-2); | |
| (I-1) + (V-3), | (I-2) + (V-3), | (I-3) + (V-3), | (I-4) + (V-3), | (I-5) + (V-3), |
| (I-16) + (V-3), | (I-7) + (V-3), | (I-8) + (V-3), | (I-9) + (V-3), | (I-10) + (V-3), |
| (I-10) + (V-3), | (I-12) + (V-3), | (I-13) + (V-3), | (I-14) + (V-3); | |
| (I-1) + (V-4), | (I-2) + (V-4), | (I-3) + (V-4), | (I-4) + (V-4), | (I-5) + (V-4), |
| (I-16) + (V-4), | (I-7) + (V-4), | (I-8) + (V-4), | (I-9) + (V-4), | (I-10) + (V-4), |
| (I-10) + (V-4), | (I-12) + (V-4), | (I-13) + (V-4), | (I-14) + (V-4); | |
| (I-1) + (V-5), | (I-2) + (V-5), | (I-3) + (V-5), | (I-4) + (V-5), | (I-5) + (V-5), |
| (I-16) + (V-5), | (I-7) + (V-5), | (I-8) + (V-5), | (I-9) + (V-5), | (I-10) + (V-5), |
| (I-10) + (V-5), | (I-12) + (V-5), | (I-13) + (V-5), | (I-14) + (V-5); | |
| (I-1) + (V-6), | (I-2) + (V-6), | (I-3) + (V-6), | (I-4) + (V-6), | (I-5) + (V-6), |
| (I-16) + (V-6), | (I-7) + (V-6), | (I-8) + (V-6), | (I-9) + (V-6), | (I-10) + (V-6), |
| (I-10) + (V-6), | (I-12) + (V-6), | (I-13) + (V-6), | (I-14) + (V-6); | |
| (I-1) + (V-7), | (I-2) + (V-7), | (I-3) + (V-7), | (I-4) + (V-7), | (I-5) + (V-7), |
| (I-16) + (V-7), | (I-7) + (V-7), | (I-8) + (V-7), | (I-9) + (V-7), | (I-10) + (V-7), |
| (I-10) + (V-7), | (I-12) + (V-7), | (I-13) + (V-7), | (I-14) + (V-7); | |
| (I-1) + (V-8), | (I-2) + (V-8), | (I-3) + (V-8), | (I-4) + (V-8), | (I-5) + (V-8), |
| (I-16) + (V-8), | (I-7) + (V-8), | (I-8) + (V-8), | (I-9) + (V-8), | (I-10) + (V-8), |
| (I-10) + (V-8), | (I-12) + (V-8), | (I-13) + (V-8), | (I-14) + (V-8); | |
| (I-1) + (V-9), | (I-2) + (V-9), | (I-3) + (V-9), | (I-4) + (V-9), | (I-5) + (V-9), |
| (I-16) + (V-9), | (I-7) + (V-9), | (I-8) + (V-9), | (I-9) + (V-9), | (I-10) + (V-9), |
| (I-10) + (V-9), | (I-12) + (V-9), | (I-13) + (V-9), | (I-14) + (V-9); | |
| (I-1) + (V-10), | (I-2) + (V-10), | (I-3) + (V-10), | (I-4) + (V-10), | (I-5) + (V-10), |
| (I-16) + (V-10), | (I-7) + (V-10), | (I-8) + (V-10), | (I-9) + (V-10), | (I-10) + (V-10), |
| (I-10) + (V-10), | (I-12) + (V-10), | (I-13) + (V-10), | (I-14) + (V-10); | |
| (I-1) + (V-11), | (I-2) + (V-11), | (I-3) + (V-11), | (I-4) + (V-11), | (I-5) + (V-11), |
| (I-6) + (V-11), | (I-7) + (V-11), | (I-8) + (V-11), | (I-9) + (V-11), | (I-10) + (V-11), |
| (I-10) + (V-11), | (I-12) + (V-11), | (I-13) + (V-11), | (I-14) + (V-11). | |

The compounds mentioned herein as safeners (antidotes) reduce or avoid phytotoxic effects which can occur when employing the herbicidal active substances of the formula (I) in crops of useful plants without substantially adversely affecting the activity of these herbicidal active substances against harmful plants. This allows the field of application of traditional crop protection agents to be widened quite considerably and to be extended for example to crops such as wheat, barley, rice and maize, in which the use of the herbicides has hitherto not been possible, or possible to a limited extent only, that is to say at low dosage rates with little broad-spectrum action.

The herbicidal active substances and the abovementioned safeners can be applied together (as a readymix or by the tank mix method) or in succession in any desired order. The weight ratio of safener to herbicidal active substance can vary within wide ranges and is preferably in the range of from 1:100 to 100:1, in particular 1:10 to 10:1. The amounts of herbicidal active substance and safener which are optimal in each case depend on the type of herbicidal active substance used or on the safener used and on the nature of the plant stand to be treated and can be determined on a case-by-case basis by simple preliminary routine experiments.

Main fields of application for the use of the combinations according to the invention are in particular maize and cereal crops such as, for example, wheat, rye, barley, oats, rice, sorghum, but also cotton and soybeans, preferably cereals, rice and maize.

Depending on their properties, the safeners employed in accordance with the invention can be used for pretreating the seed of the crop plant (seed dressing), incorporated pre-planting into the seed furrows, or applied before or after plant emergence together with the herbicide. Pre-emergence treatment includes not only the treatment of the area under cultivation prior to planting, but also the treatment of the areas under cultivation where seed has been sown, but no growth is observed as yet. The joint application together with the herbicide is preferred. Tank mixes or readymixes can be employed for this purpose.

The application rate of safener required can vary within wide limits, depending on the indication and the herbicidal active substance used, and, as a rule, amount to from 0.001 to 5 kg, preferably from 0.005 to 0.5 kg of active substance per hectare.

The present invention therefore also relates to a method for protecting crop plants from phytotoxic side effects of herbicides of the formula (I), which comprises applying an antidote-effective amount of a compound of the formulae (II) to (V) before, after or together with the herbicidal active substance A of the formula (I) to the plants, plant seeds or the area under cultivation.

The herbicide/safener combination according to the invention can also be employed for controlling harmful plants in crops of known genetically modified plants or genetically modified plants yet to be developed. As a rule, the transgenic plants are distinguished by particular, advantageous properties, for example by resistances to certain crop protection agents, resistances to plant diseases or plant pathogens such as certain insects or microorganisms, such as fungi, bacteria or viruses. Other particular properties relate for example to the harvested material with regard to quantity, quality, shelf life, composition and specific constituents. Thus, transgenic plants with an increased starch content or in which the quality of the starch is altered, or those having a different fatty acid composition of the harvested material, are known.

The combinations according to the invention are preferably used in economically important transgenic crops of useful plants and ornamentals, for example of cereals such as wheat, barley, rye, oats, sorghum and millet, rice, cassava and maize, or else crops of sugar beet, cotton, soybeans, oilseed rape, potatoes, tomatoes, peas and other vegetables.

When using the combinations according to the invention in transgenic crops, effects which are specific for the application in the transgenic crop in question, in addition to the action against harmful plants to be observed in other crops, for example a modified or specifically widened spectrum of action which can be controlled, modified application rates which can be employed for the application, preferably good combining ability with the herbicides to which the transgenic crop is resistant, and an effect on growth and yield of the transgenic crop plants.

The invention therefore also relates to the use of the combination according to the invention for controlling harmful plants in transgenic crop plants.

The safeners of the formulae (II) to (V) and their combinations with one or more of the abovementioned herbicidal active substances of the formula (I) can be formulated in many ways, depending on the biological and/or chemico-physical parameters which prevail. Examples of suitable formulations which are possible are: wettable powders (WP), emulsifiable concentrates (EC), water-soluble powders (SP), water-soluble concentrates (SL), concentrated emulsions (BW) such as oil-in-water and water-in-oil emulsions, sprayable solutions or emulsions, capsule suspensions (CS), oil- or water-based dispersions (SC), suspoemulsions, suspension concentrates, dusts (DP), oil-miscible solutions (OL), seed-dressing materials, granulates (GR) in the form of microgranules, spray granules, coated granules and adsorption granules, granules for soil application or broadcasting, water-soluble granules (SG), water-dispersible granules (WG), ULV formulations, microcapsules and waxes.

These individual formulation types are known in principle and are described, for example, in: Winnacker-Küchler, “Chemische Technologie”[Chemical Engineering], Volume 7, C. Hauser Verlag Munich, 4th Ed. 1986; Wade van Valkenburg, “Pesticide Formulations”, Marcel Dekker N.Y., 1973; K. Martens, “Spray Drying Handbook”, 3rd Ed. 1979, G. Goodwin Ltd. London.

The formulation auxiliaries optionally required, such as inert materials, surfactants, solvents and further additives, are likewise known and are described, for example, in: Watkins, “Handbook of Insecticide Dust Diluents and Carriers”, 2nd Ed., Darland Books, Caldwell N.J., H.v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem.

Publ. Co. Inc., N.Y. 1964; Schönfeldt, “Grenzflächenaktive Äthylenoxidaddukte” [Surface-active ethylene oxide adducts], Wiss. Verlagsgesell., Stuttgart 1976; Winnacker-Küchler, “Chemische Technologie”, Band 7, C. Hauser Verlag Munich, 4 Ed. 1986.

Based on these formulations, combinations with other substances which are active as crop protection agents, such as insecticides, acaricides, herbicides, fungicides, and with safeners, fertilizers and/or growth regulators may also be prepared, for example in the form of a readymix or a tankmix.

Wettable powders are preparations which are uniformly dispersible in water and which, in addition to the active substance, also contain ionic and/or nonionic surfactants (wetters, dispersants), for example polyoxyethylated alkylphenols, polyoxyethylated fatty alcohols, polyoxyethylated fatty amines, fatty alcohol polyglycol ether sulfates, alkanesulfonates, alkylbenzenesulfonates, sodium 2,2′-dinaphthylmethane-6,6′-disulfonate, sodium lignosulfonate, sodium dibutylnaphthalenesulfonate or else sodium oleoylmethyltaurate, in addition to a diluent or inert substance. To prepare the wettable powders, the herbicidal active substances are ground finely, for example in customary equipment such as hammer mills, blowing mills and air-jet mills, and simultaneously or subsequently mixed with the formulation auxiliaries.

Emulsifiable concentrates are prepared for example by dissolving the active substance in an organic solvent, e.g. butanol, cyclohexanone, DMF or else higher-boiling hydrocarbons such as saturated or unsaturated aliphatic or alicyclic substances, aromatic substances or mixtures of the organic solvents with addition of one or more ionic and/or nonionic surfactants (emulsifiers). Examples of emulsifiers which can be used are: calcium alkylarylsulfonates such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan esters such as, for example, sorbitan fatty acid esters or polyoxyethylene sorbitan esters such as, for example, polyoxyethylene sorbitan fatty acid esters. Dusts are generally obtained by grinding the active substance with finely divided solid materials, for example talc, natural clays such as kaolin, bentonite and pyrophyllite, or diatomaceous earth.

Suspension concentrates can be water-based or oil-based. They can be prepared for example by wet-grinding by means of customary bead mills, if appropriate with addition of surfactants, as have already been mentioned for example above in the case of the other formulation types.

Emulsions, for example oil-in-water emulsions (EW), can be prepared for example by means of stirrers, colloid mills and/or static mixers using aqueous organic solvents and, if appropriate, surfactants as have already been mentioned for example above in the case of the other formulation types.

Granules can be prepared either by spraying the active substance onto adsorptive, granulated inert material or by applying active substance concentrates to the surface of carriers such as sand, kaolinites or granulated inert material with the aid of stickers, for example polyvinyl alcohol, sodium polyacrylate or else mineral oils. Suitable active substances can also be granulated in the fashion which is conventional for the production of fertilizer granules, if desired as a mixture with fertilizers. Water-dispersible granules are generally prepared by customary methods such as spray drying, fluidized-bed granulation, disk granulation, mixing with high-speed stirrers and extrusion without solid inert material.

To prepare disk granules, fluidized-bed granules, extruder granules and spray granules, see, for example methods in “Spray-Drying Handbook” 3rd ed. 1979, G. Goodwin Ltd., London; J. E. Browning, “Agglomeration”, Chemical and Engineering 1967, pages 147 et seq., “Perry's Chemical Engineer's Handbook”, 5th Ed., McGraw-Hill, New York 1973, pp. 8-57.

For further details on the formulation of crop protection products see, for example, G. C. Klingman, “Weed Control as a Science”, John Wiley and Sons, Inc., New York, 1961, pages 81-96 und J. D. Freyer, S. A. Evans, “Weed Control Handbook”, 5th Ed., Blackwell Scientific Publications, Oxford, 1968, pages 101-103.

As a rule, the agrochemical preparations comprise 0.1 to 99% by weight, in particular 0.1 to 95% by weight, of active substance of the formulae (II) to (V) or of the herbicide/antidote active substance mixture (I) and (II)/(III)/(IV)/(V) and 1 to 99.9% by weight, in particular 5 to 99.8% by weight, of a solid or liquid additive and 0 to 25% by weight, in particular 0.1 to 25% by weight, of a surfactant.

In wettable powders, the active substance concentration is, for example, approximately 10 to 90% by weight, the remainder to 100% by weight being composed of customary formulation constituents. In the case of emulsifiable concentrates, the active substance concentration can amount approximately to 1 to 80% by weight. Formulations in the form of dusts comprise 1 to 20% by weight of active substance, and sprayable solutions comprise approximately 0.2 to 20% by weight of active substance. In the case of granules, such as water-dispersible granules, the active substance content depends partly on whether the active compound is in liquid or solid form. In the case of water-dispersible granules, the active substance content is generally between 10 and 90% by weight.

In addition, the active substance formulations mentioned comprise, if appropriate, the auxiliaries which are conventional in each case, such as stickers, wetters, dispersants, emulsifiers, penetrants, preservatives, antifreeze agents, solvents, fillers, carriers, colorants, antifoams, evaporation inhibitors, and pH and viscosity regulators.

The application rates of the herbicides of the formula (I) required varies with the external conditions such as temperature, humidity, the type of the herbicide used, and the like. It can be varied within wide limits, for example between 0.001 and 10.0 kg/ha or more of active substance, but it is preferably between 0.005 and kg/ha.

The following examples serve to explain the invention:

A. Formulation Examples

a) A dust is obtained by mixing 10 parts by weight of a compound of the formula (II) to (V) or of an active substance mixture of a herbicidal active substance of the formula (I) and a safener of the formula (II) to (V) and 90 parts by weight of talc as inert substance and comminuting the mixture in a hammer mill.

b) A wettable powder which is readily dispersible in water is obtained by mixing 25 parts by weight of a compound of the formula (II) to (V) or of an active substance mixture of a herbicidal active substance of the formula (I) and a safener of the formula (II) to (V), 64 parts by weight of kaolin-containing quartz as inert substance, 10 parts by weight of potassium lignosulfonate and 1 part by weight of sodium oleoylmethyltaurate as wetter and dispersant and grinding the mixture in a pinned-disk mill.

c) A dispersion concentrate which is readily dispersible in water is obtained by mixing 20 parts by weight of a compound of the formula (II) to (V) or of an active substance mixture of a herbicidal active substance of the formula (I) and a safener of the formula (II) to (V), 6 parts by weight of alkylphenol polyglycol ether (®Triton X 207), 3 parts by weight of isotridecanol polyglycol ether (8 EO) and 71 parts by weight of paraffinic mineral oil (boiling range, for example, approx. 255 to over 277° C.) and grinding the mixture in a friction ball mill to a fineness of below 5 microns.

d) An emulsifiable concentrate is obtained from 15 parts by weight of a compound of the formula (II) to (V) or of an active substance mixture of a herbicidal active substance of the formula (I) and a safener of the formula (II) to (V), 75 parts by weight of cyclohexanone as solvent and 10 parts by weight of oxyethylated nonylphenol as emulsifier.

e) Water-dispersible granules are obtained by mixing

| | |
|---|---|
| 75 parts by weight | of a compound of the formula (II) to (V) or |
| | of an active substance mixture of a herbicidal |
| | active substance of the formula (I) and a safener |
| | of the formula (II) to (V), |
| 10 parts by weight | of calcium lignosulfonate, |
| 5 parts by weight | of sodium lauryl sulfate, |
| 3 parts by weight | polyvinyl alcohol and |
| 7 parts by weight | kaolin, |

grinding the mixture in a pinned-disk mill and granulating the powder in a fluidized bed by spraying on water as granulating fluid.

f) Water-dispersible granules are also obtained by homogenizing and precomminuting, in a colloid mill,

| | |
|---|---|
| 25 parts by weight | of a compound of the formula (II) to (V) or |
| | of an active substance mixture of a herbicidal |
| | active substance of the formula (I) and a safener of |
| | the formula (II) to (V), |
| 5 parts by weight | of sodium 2,2′-dinaphthylmethane-6,6′-disulfonate, |
| 2 parts by weight | of sodium oleoylmethyltaurate, |
| 1 parts by weight | of polyvinyl alcohol, |
| 17 parts by weight | of calcium carbonate and |
| 50 parts by weight | of water, |

subsequently grinding the mixture in a bead mill and atomizing and drying the suspension obtained in a spray tower by means of a single-substance nozzle.

B. Biological Examples

B.1 Post-Emergence Experiments:

Seeds of useful plants are placed in pots (diameter: 9 to 13 cm) in sandy loam and covered with soil. The test plants are treated in the three-leaf stage, that is to say approximately three weeks after planting, with the herbicides formulated as emulsifiable concentrates or dusts (application rate: 200 g of active substance per hectare) in the form of aqueous dispersions or suspensions or emulsions, using a water application rate of 300 to 800 l/ha (converted), which is sprayed onto the green parts of the plants at various dosage rates. For growing-on the plants, the pots are kept in the greenhouse under optimal conditions. The damage symptoms to useful plants and harmful plants are assessed visually 2-3 weeks after the treatment.

The experimental results are compiled in Tables 6, 7 and 8. They show the reduction of the phytotoxic effect in percent of the herbicide/safener combinations according to the invention in comparison with the use of the herbicide alone. Depending on the application rate, the type of the useful plant and the type of the composition according to the invention, the damage symptoms are lessened by up to 100% in comparison with the use of the herbicide alone. The dosage rate is stated in grams of active substance per hectare (g a.i./ha).

TABLE 6

| | | Lessening of the damage |
|---|---|---|
| | | symptoms in wheat (variety “Rektor”) |
| | Dosage rate | in comparison with the |
| Compound | [g/ha] | use of the herbicide alone |
| (I-2) + (II-3) | 200 + 200 | −77% |
| (I-2) + (IV-1) | 200 + 200 | −100% |

TABLE 7

| | | Lessening of the damage symptoms |
|---|---|---|
| | | in wheat (variety “Orjaune”) in |
| | Dosage rate | comparison with the use |
| Compound | [g/ha] | of the herbicide alone |
| (I-2) + (II-3) | 200 + 200 | −92% |
| (I-2) + (IV-1) | 200 + 200 | −83% |

TABLE 8

| | | Lessening of the damage symptoms in |
|---|---|---|
| | Dosage rate | barley (variety “Duet”) in comparison |
| Compound | [g/ha] | with the use of the herbicide |
| (I-2) + (II-3) | 200 + 80 | −100% |
| (I-2) + (IV-1) | 200 + 80 | −100% |

B.2 Post-Emergence Experiments (Field Experiment)

Seeds of useful plants are placed in the soil in the open and covered with the soil. The plants are treated in the 3- to 5-leaf stage with the herbicides, which are formulated as emulsifiable concentrates or dusts, and, for comparison purposes, with herbicides and safeners in the form of aqueous dispersions or suspensions or emulsions at a water application rate of 300 to 800 l/ha (converted) at various dosage rates. The damage symptoms on the useful plants are assessed visually 7 days after the treatment.

The experimental results are compiled in Tables 9 and 10. They show the reduction of the phytotoxic effect in percent of the herbicide/safener combinations according to the invention in comparison with the use of the herbicide alone. Depending on the application rate, the type of the useful plant and the type of the composition according to the invention, the damage symptoms are lessened by up to 60% in comparison with the use of the herbicide alone. The dosage rate is stated in grams of active substance per hectare (g a.i./ha).

TABLE 9

| | | Lessening of the damage symptoms |
|---|---|---|
| | Dosage rate | in spring wheat in comparison |
| Compound | [g/ha] | with the use of the herbicide alone |
| (I-2) + (II-3) | 150 + 75 | −57% |

TABLE 10

| | | Lessening of the damage |
|---|---|---|
| | Dosage rate | symptoms in maize in comparison |
| Compound | [g/ha] | with the use of the herbicide alone |
| (I-2) + (III-2) | 150 + 75 | −26% |

1. A herbicidal composition comprising a herbicidally active amount of a component A and an antidote-effective component B, where component A is a compound of the formula (I) or its salts, 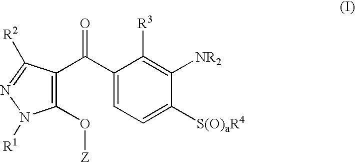
where the symbols and indices have the following meanings:
R¹ is (C₁-C₄)-alkyl, (C₃-C₄)-cycloalkyl, (C₂-C₄)-alkenyl or (C₂-C₄)-alkynyl;
R² is hydrogen, CH₂OCH₃, (C₁-C₃)-alkyl or cyclopropyl;
R³ is halogen, (C₁-C₄)-alkyl, (C₃-C₄)-cycloalkyl, (C₁-C₂)-alkoxy, CH₂OCH₃ or CH(CH₃)OCH₃;
R⁴ is (C₁-C₄)-alkyl;
Z is hydrogen, or benzyl which is substituted by radicals selected from the group consisting of halogen, cyano, CF₃, nitro, (C₁-C₂)-alkyl and (C₁-C₂)-alkoxy;
R in NR₂ is
(a). hydrogen,
(b). (C₁-C₄)-alkyl,
(c). (C₃-C₄)-cycloalkyl,
(d). (C₃-C₄)-alkenyl,
(e). (C₃-C₄)-alkynyl,
(f). any one of (b)-(e) which is substituted by v radicals selected from the group consisting of halogen, cyano, (C₁-C₄)-alkoxy, (C₃-C₄)-cycloalkoxy and (C₁-C₃)-fluoroalkoxy, or
(g). benzyl which is substituted by v radicals selected from the group consisting of halogen, cyano, nitro, CF₃, (C₁-C₂)-alkoxy and (C₁-C₂)-alkyl; or
NR₂ is a 5-, 6- or 7-membered saturated, partially saturated, unsaturated or aromatic radical comprising c nitrogen atoms and t oxygen atoms, which radical is substituted by v radicals selected from the group consisting of halogen, cyano, (C₁-C₄)-alkyl, (C₃-C₄)-cycloalkyl, (C₁-C₃)-fluoroalkyl, (C₁-C₄)-alkoxy, (C₃-C₄)-cycloalkoxy, (C₁-C₃)-fluoroalkoxy, (C₁-C₃)-alkoxymethyl and by v radicals selected from the group consisting of halogen-, cyano-, nitro-, CF₃—, (C₁-C₂)-alkoxy- and (C₁-C₂)-alkyl-substituted phenyl;
a is independently 0, 1 or 2;
c is independently 1 or 2;
t is independently 0 or 1;
v is independently 0, 1, 2 or 3
and component B is one or more compounds of the formulae (II), (III), (IV) and (V), or its salts, 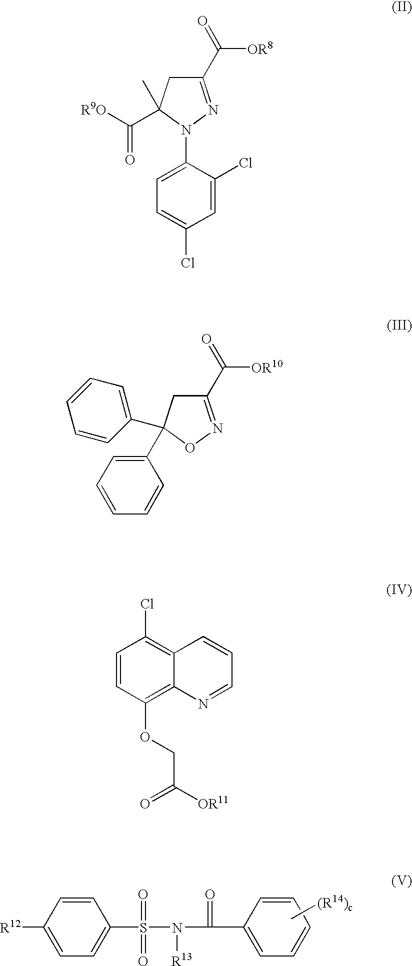
where the symbols have the following meanings:
R⁸, R⁹, and R¹⁰ are in each case independently of one another hydrogen, or (C₁-C₄)-alkyl;
R¹¹ is hydrogen or (C₁-C₈)-alkyl;
R¹² is CO—NR¹⁵R¹⁶ or NH—CO—R¹⁷;
R¹³ is hydrogen, (C₁-C₄)-alkyl, (C₂-C₄)-alkenyl or (C₂-C₄)-alkynyl;
R¹⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkyl-sulfinyl, (C₁-C₄)-alkylsulfonyl, (C₁-C₄)-alkoxycarbonyl or (C₁-C₄)-alkylcarbonyl;
R¹⁵ is
(a). hydrogen,
(b). (C₁-C₆)-alkyl,
(c). (C₃-C₆)-cycloalkyl,
(d). (C₂-C₆)-alkenyl,
(e). (C₂-C₆)-alkynyl,
(f). (C₅-C₆)-cycloalkenyl,
(g). phenyl,
(h). 3- to 6-membered heterocyclyl comprising n hetero atoms selected from the group consisting of nitrogen, oxygen and sulfur,
(i). any one of (b)-(h) radicals being substituted by v substituents selected from the group consisting of halogen, (C₁-C₆)-alkoxy, (C₁-C₆)-haloalkoxy, (C₁-C₂)-alkylsulfinyl, (C₁-C₂)-alkyl-sulfonyl, (C₃-C₆)-cycloalkyl, (C₁-C₄)-alkoxycarbonyl, (C₁-C₄)-alkylcarbonyl and phenyl or,
(j). any one of (c), (f) and (g) cyclic radicals also being substituted by (C₁-C₄)-alkyl and (C₁-C₄)-haloalkyl;
R¹⁶ is
(a). hydrogen,
(b). (C₁-C₆)-alkyl,
(c). (C₂-C₆)-alkenyl,
(d). (C₂-C₆)-alkynyl, or
(e). any one of (b)-(d) radicals being substituted by v radicals selected from the group consisting of halogen, hydroxyl, (C₁-C₄)-alkyl, (C₁-C₄)-alkoxy and (C₁-C₄)-alkylthio;
R¹⁷ is
(a). hydrogen,
(b). (C₁-C₄)-alkylamino,
(c). di-(C₁-C₄)-alkylamino,
(d). (C₁-C₆)-alkyl,
(e). (C₃-C₆)-cycloalkyl,
(f). any one of (b)-(e) radicals which is substituted by v radicals selected from the group consisting of halogen, (C₁-C₄)-alkoxy, halo(C₁-C₄)-alkoxy and (C₁-C₄)-alkylthio, or
(g). (C₃-C₆)-cycloalkyl which is substituted by v radicals selected from the group consisting of (C₁-C₄)-alkyl and (C₁-C₄)-haloalkyl;
c is independently 1 or 2;
n is independently 1, 2 or 3;
a, t and v are as defined above,
including stereoisomers of the component A or component B.

2. A herbicidal composition as claimed in claim 1 which comprises, as component B, one or more compounds of the formulae (II), (III) and (V).

3. A herbicidal composition as claimed in claim 1, wherein
R¹ is (C₁-C₄)-alkyl;
R² is hydrogen or (C₁-C₃)-alkyl;
R³ is halogen or (C₁-C₃)-alkyl;
R⁴ is (C₁-C₄)-alkyl;
Z is hydrogen or benzyl;
R in NR₂ is hydrogen or (C₁-C₄)-alkyl which is substituted by v (C₁-C₄)-alkoxy radicals; or
NR₂ is a 5-, 6- or 7-membered saturated, partially saturated, unsaturated or aromatic radical comprising c nitrogen atoms and t oxygen atoms, which radical is substituted by v radicals selected from the group consisting of halogen, cyano, (C₁-C₄)-alkyl, (C₃-C₄)-cycloalkyl, (C₁-C₃)-fluoroalkyl, (C₁-C₄)-alkoxy, (C₃-C₄)-cycloalkoxy, (C₁-C₃)-fluoroalkoxy and (C₁-C₃)-alkoxymethyl.

4. A herbicidal composition as claimed in claim 1, which comprises, as component B, one or more compounds of the formulae (II) or (III) where R⁸, R⁹ and R¹⁰ independently of one another are hydrogen or (C₁-C₂)-alkyl.

5. A herbicidal composition as claimed in claim 1, which comprises, as component B, one or more compounds of the formula (V) where the symbols have the following meanings:
R¹² is CONR¹⁵R¹⁶;
R¹³ is hydrogen;
R¹⁴ is halogen, (C₁-C₄)-alkyl or (C₁-C₄)-alkoxy;
R¹⁵ is (C₁-C₆)-alkyl or (C₃-C₆)-cycloalkyl; and
R¹⁶ is hydrogen or (C₁-C₆)-alkyl.

6. A herbicidal composition as claimed in claim 1, which comprises, as component B, one or more compounds of the formula (V) where the symbols have the following meanings:
R¹² is NH—COR¹⁷;
R¹³ is hydrogen;
R¹⁴ is halogen, (C₁-C₄)-alkyl or (C₁-C₄)-alkoxy; and
v is 1.

7. A method for controlling harmful plants wherein a herbicidal composition as claimed in claim 1, is applied jointly or separately pre-emergence, post-emergence or pre- and post-emergence to the plants, plant parts, plants seeds or the areas on which the plants grow.

8. A method as claimed in claim 7 for the selective control of harmful plants in plant crops selected from the group consisting of maize, wheat, rye, barley, oats, rice, sorghum, cotton, sugar cane and soybeans.

9. A method as claimed in claim 8, wherein the plant crops are genetically modified or obtained by mutation selection.

10. (Cancelled).

11. A herbicidal composition as claimed in claim 2, which comprises, as component A, compounds of the formula (I) in which the symbols and indices have the following meanings:
R¹ is (C₁-C₄)-alkyl;
R² is hydrogen or (C₁-C₃)-alkyl;
R³ is halogen or (C₁-C₃)-alkyl;
R⁴ is (C₁-C₄)-alkyl;
Z is hydrogen or benzyl;
R in NR₂ is hydrogen or (C₁-C₄)-alkyl which is substituted by v (C₁-C₄)-alkoxy radicals; or
NR₂ is a 5-, 6- or 7-membered saturated, partially saturated, unsaturated or aromatic radical comprising c nitrogen atoms and t oxygen atoms, which radical is substituted by v radicals selected from the group consisting of halogen, cyano, (C₁-C₄)-alkyl, (C₃-C₄)-cycloalkyl, (C₁-C₃)-fluoroalkyl, (C₁-C₄)-alkoxy, (C₃-C₄)-cycloalkoxy, (C₁-C₃)-fluoroalkoxy and (C₁-C₃)-alkoxymethyl.

12. A herbicidal composition as claimed in claim 2, which comprises, as component B, one or more compounds of the formulae (II) or (III) where R⁸, R⁹ and R¹⁰ independently of one another are hydrogen or (C₁-C₂)-alkyl.

13. A herbicidal composition as claimed in claim 3, which comprises, as component B, one or more compounds of the formulae (II) or (III) where R⁸, R⁹ and R¹⁰ independently of one another are hydrogen or (C₁-C₂)-alkyl.

14. A herbicidal composition as claimed in claim 2, which comprises, as component B, one or more compounds of the formula (V) where the symbols have the following meanings:
R¹² is CONR¹⁵R¹⁶;
R¹³ is hydrogen;
R¹⁴ is halogen, (C₁-C₄)-alkyl or (C₁-C₄)-alkoxy;
R¹⁵ is (C₁-C₆)-alkyl or (C₃-C₆)-cycloalkyl; and
R¹⁶ is hydrogen or (C₁-C₆)-alkyl.

15. A herbicidal composition as claimed in claim 3, which comprises, as component B, one or more compounds of the formula (V) where the symbols have the following meanings:
R¹² is CONR¹⁵R¹⁶;
R¹³ is hydrogen;
R¹⁴ is halogen, (C₁-C₄)-alkyl or (C₁-C₄)-alkoxy;
R¹⁵ is (C₁-C₆)-alkyl or (C₃-C₆)-cycloalkyl; and
R¹⁶ is hydrogen or (C₁-C₆)-alkyl.

16. A herbicidal composition as claimed in claim 2, which comprises, as component B, one or more compounds of the formula (V) where the symbols have the following meanings:
R¹² is NH—COR¹⁷;
R¹³ is hydrogen;
R¹⁴ is halogen, (C₁-C₄)-alkyl or (C₁-C₄)-alkoxy; and
v is 1.

17. A herbicidal composition as claimed in claim 3, which comprises, as component B, one or more compounds of the formula (V) where the symbols have the following meanings:
R¹² is NH—COR¹⁷;
R¹³ is hydrogen;
R¹⁴ is halogen, (C₁-C₄)-alkyl or (C₁-C₄)-alkoxy; and
v is 1.

18. A herbicidal composition as claimed in claim 1, wherein
NR₂ is 1 pyrrolidinyl, 2-pyrrolidinyl, 3 pyrrolidinyl, 3-isoxazoldinyl, 4-isoxazolidinyl, 5-isoxoazolidinyl, 1 pyrazolidinyl, 3 pyrazolidinyl, 4-pyrazolidinyl, 5-pyrazolidinyl, 2-oxazolidinyl, 4-oxazolidinyl, 5 oxazolidinyl, 2 imidazolidinyl, 4 imidazolidinyl, 1,2,4-oxadiazolidin-3-yl, 1,2,4-oxadiazolidin-5-yl, 1,3,4 oxadiazolidin-2-yl, 2,3-dihydropyrrol-2-yl, 2,3-dihydropyrrol-3-yl, 2,3 dihydropyrrol-4-yl, 2,3-dihydropyrrol-5-yl, 2,5 dihydropyrrol-2-yl, 2,5 dihydropyrrol-3-yl, 2,3-dihydroisoxazol-3-yl, 2,3 dihydroisoxazol-4-yl, 2,3 dihydroisoxazol-5-yl, 4,5-dihydroisoxazol-3-yl, 4,5 dihydroisoxazol-4-yl, 4,5 dihydroisoxazol-5-yl, 2,3-dihydroisothiazol-3-yl, 2,3 dihydroisothiazol-4-yl, 2,3 dihydroisothiazol-5-yl, 4,5-dihydroisothiazol-3-yl, 4,5-dihydroisothiazol-4-yl, 4,5 dihydroisothiazol-5-yl, 2,5-dihydroisothiazol-3-yl, 2,5-dihydroisothiazol-4-yl, 2,5 dihydroisothiazol-5-yl, 2,3-dihydrooxazol-3-yl, 2,3 dihydrooxazol-4-yl, 2,3 dihydrooxazol-5-yl, 4,5-dihydrooxazol-3-yl, 4,5 dihydrooxazol-4-yl, 4,5 dihydrooxazol-5-yl, 2,5-dihydrooxazol-3-yl, 2,5 dihydrooxazol-4-yl, 2,5 dihydrooxazol-5-yl, 2,3-dihydroimidazol-2-yl, 2,3 dihydroimidazol-4-yl, 2,3 dihydroimidazol-5-yl, 4,5-dihydroimidazol-2-yl, 4,5 dihydroimidazol-4-yl, 4,5 dihydroimidazol-5-yl, 2,5-dihydroimidazol-2-yl, 2,5 dihydroimidazol-4-yl, 2,5 dihydroimidazol-5-yl, 1-morpholinyl, 2-morpholinyl, 3 morpholinyl, 1-piperidinyl, 2-piperidinyl, 3-piperidinyl, 4-piperidinyl, 3 tetrahydropyridazinyl, 4 tetrahydro-pyridazinyl, 2-tetrahydropyrimidinyl, 4 tetrahydropyrimidinyl, 5-tetrahydropyrimidinyl, 2-tetrahydropyrazinyl, 1,3-dihydrooxazin-2-yl, 3,4,5,6-tetrahydropyridin-2 yl, 1,3 dihydrooxazin-2-yl, 2-pyrrolyl, 3-pyrrolyl, 1-pyrazolyl, 3-pyrazolyl, 4-pyrazolyl, 5 pyrazolyl, 2-imidazolyl, 4-imidazolyl, 1-pyrrolyl, 2-pyrrolyl, 3-pyrrolyl, 3-isoxazolyl, 4-isoxazolyl, 5-isoxazolyl, 3-pyrazolyl, 4-pyrazolyl, 5-pyrazolyl, 2-oxazolyl, 4-oxazolyl, 5-oxazolyl, 2-imidazolyl, 1,2,4-oxadiazol-3-yl, 1,2,4-oxadiazol-5-yl, 1,3,4-oxadiazol-2 yl, 2-pyridinyl, 3-pyridinyl, 4-pyridinyl, 3-pyridazinyl, 4-pyridazinyl, 2 pyrimidinyl, 4 pyrimidinyl, 5-pyrimidinyl or 2-pyrazinyl.

19. A herbicidal composition as claimed in claim 1, wherein
R³ is chlorine or methyl.

20. A herbicidal composition as claimed in claim 1, wherein
R⁴ is methyl;
Z is hydrogen; and
a is 2.

21. A herbicidal composition as claimed in claim 1, wherein
R¹³ is hydrogen.
